(19) United States
(12) Patent Application Publication
(10) Pub. No.: US 2009/0070145 A1
(43) Pub. Date: Mar. 12, 2009

(54) Method and system for coronary artery disease care

(76) Inventor: Sultan Haider, Erlangen (DE)

Correspondence Address: BRINKS HOFER GILSON & LIONE, P.O. BOX 10395, CHICAGO, IL, 60610, US

(21) Appl. No.: 11/978,760

(22) Filed: Oct. 29, 2007

Related U.S. Application Data
(60) Provisional application No. 60/993,237, filed on Sep. 10, 2007.

(51) Int. Cl. G06Q 50/00

(52) U.S. Cl. 705/3

(57) ABSTRACT

A system and method for evaluating patient risk factors and managing the care of patients with risk factors or symptoms of cardiovascular disease is described. A form-based data entry device is used to retrieve medical history data of a patient, to enter updated data, and to request further medical tests and studies. A rule-based analysis engine is used to process the data so as to permit a user to interact with the system so as to determine a suitable care path for either long-term or acute situations. The rule-based engine may be modified to reflect the capabilities and diagnostic equipment suite available at a specific medical facility, and to implement a version of an approved medical protocol consistent with the local constraints. Some of the form-based data may be entered by emergency personnel while the patient is in transit to the treatment facility.

This application claims the benefit of U.S. Provisional application Ser. No. 60/933,237, filed on Sep. 10, 2007, which is incorporated herein by reference.

### TECHNICAL FIELD

The present application relates to a method and system of improving patient care by assisting in the diagnosis and care for coronary artery disease.

### BACKGROUND

Coronary artery disease (CAD), which is the end result of the accumulation of atheromatous plaques within the walls of the arteries that supply the myocardium, remains the number one cause of disability and death in modern industrialized countries. In 2005, the estimated direct and indirect cost of CAD in the US is $393.5 billion. In the US in 2001, nearly 900,000 Americans experienced a new or recurrent heart attack, or acute myocardial infarction.

Risk mitigation strategies include weight control, treatment or prevention of diabetes, and physical exercise; special diets that are low in salt or fat may be recommended. Outpatient treatment with drugs on a short or long-term basis may also be indicated. Most patients discharged from a hospital after treatment are referred to general physicians. The patients may be monitored on a long term basis for changes in metabolic parameters, which may include blood chemistry, so that the treatment plan can be adjusted accordingly.

A range of metabolic factors such as may be obtained from blood tests, such as cholesterol level including total cholesterol, high- and low-density cholesterol, triglycerides, biomarkers such as high sensitivity C-reactive protein, homocysteine and blood sugar control (hemoglobin Alc), and other measurements such as basal metabolic rate (BMR) and body mass index may also be measured on a periodic basis depending on the treatment plan.

With the progress in information technology, it has becomes possible to make medical, administrative, payment-relevant, and other data of an individual patient accessible centrally; the data itself may be located in different hospital information data bases, doctors' office information, health insurance, and other information systems.

A system and method that may be used to maintain a care plan of an individual patient, up-to-date has been disclosed in a U.S. patent application Ser. No. 11/893,664 entitled “Method and System to Manage Coronary Artery Disease Care”, by the present inventor, filed on Aug. 17, 2007 which is commonly owned and is incorporated herein by reference.”

### BRIEF SUMMARY

A method of determining appropriate care paths for long term or acute treatment of a patient with cardiovascular risk factors or symptoms is disclosed, the method including providing a plurality of computer-displayable data forms, at least one of which provides for a selection of multiple responses to each of a plurality of pre-determined questions. A link to a data base of the patient historical data may be provided and data that is available for the patient is retrieved. Data may requested from the patient history, or data therefrom that is relevant to the present situation may be spontaneously displayed. Additional studies may be requested and the results may be displayed by forms. A rule-based engine processes responses entered on the forms, and may also process data from the data base, and requested medical tests so as to provide at least a recommended care path. The rule-based engine may be adapted to conform to the existing diagnostic procedures and capabilities at a local medical facility.

In another aspect, a data processing system for managing the care path fro patient having cardiovascular risk factors or symptoms is described, the system including a data processor. The data processor is operable to maintain a form-based data entry system, and a rule-based process for processing data entered on the forms or retrieved from a patient medical history data base. Medical tests may be requested or test data reviewed using the forms. The data may be processed and using a rule-based engine to determine a care path, where the care path may be at least one of a long-term care path or an acute care path. The rule-based engine may be adapted to conform to the diagnostic procedures and decision criteria of a local medical facility.

In yet another aspect, a computer-readable medium having instructions executable on a computer stored thereon is described. The instructions cause a computer system to store and maintain a from-based data entry procedure, and to access at least one of a patient historical data base, and a care plan protocol. Data input to the form is accepted and patient historical data may be retrieved. Medical tests may be requested and the resultant data viewed in a form. The data may be processed using a rule-based engine and a care path consistent with the data is computed. The rule-based engine may be adapted to conform to the diagnostic procedures and decision criteria of a local medical facility.

### BRIEF DESCRIPTION OF THE DRAWINGS

FIG. 1 illustrates a system architecture for performing the method managing patients with cardiovascular symptoms or risk factors;

FIG. 2 is an example of a top level summary form including patient data and navigation buttons;

FIG. 3 is an example of a form for displaying summary results of an examination, including laboratory data and answers to questions;

FIG. 4 is an example of a form for displaying the results of radiological examinations;

FIG. 5 is an example of a form for displaying cardiology examination data; and

FIG. 6 is an output form for presenting laboratory data as a time series.

### DETAILED DESCRIPTION

Reference will now be made in detail to embodiments. While the invention will be described in conjunction with these embodiments, it will be understood that it is not intended to limit the invention to such embodiments. In the following description, numerous specific details are set forth in order to provide a thorough understanding of the present invention which, however, may be practiced without some or all of these specific details. In other instances, well known process operations have not been described in detail in order not to unnecessarily obscure the description.

The embodiments described herein include methods, processes, apparatuses, instructions, systems, or business concepts for diagnosing and caring for patients presenting with one or more symptoms which may be indicative of coronary artery disease. However, the examples of diseases, syndromes, conditions, and the like, and the types of examination, diagnosis and treatment protocols described herein are by way of example, and are not meant to suggest that the method and system is limited to those named, or the equivalents thereof. As the medical arts are continually advancing, the use of the methods and system described herein may be expected to encompass a broader scope in optimizing the diagnosis and treatment of patients.

The combination of hardware and software to accomplish the tasks described herein is termed a system. Where otherwise not specifically defined, acronyms are given their ordinary meaning in the art.

The instructions for implementing processes or methods of the system, may be provided on computer-readable storage media or memories, such as a cache, buffer, RAM, removable media, hard drive or other computer readable storage media. Computer readable storage media include various types of volatile and nonvolatile storage media. The functions, acts or tasks illustrated in the figures or described herein are executed in response to one or more sets of instructions stored in or on computer readable storage media. The functions, acts or tasks are independent of the particular type of instruction set, storage media, processor or processing strategy and may be performed by software, hardware, integrated circuits, firmware, micro code and the like, operating alone or in combination. Likewise, processing strategies may include multiprocessing, multitasking, parallel processing and the like.

In an embodiment, the instructions may be stored on a removable media device for reading by local or remote systems. In other embodiments, the instructions may be stored in a remote location for transfer through a computer network, a local or wide area network or over telephone lines. In yet other embodiments, the instructions are stored within a given computer or system.

The instructions may be a computer program product, stored or distributed on computer readable media, containing some or all of the instructions to be executed on a computer to perform all or a portion of the method or the operation of the system.

Medical data systems and medical procedures may be used collect information on patients, including medical history, demographic information, results of medical tests, prior treatment and outcomes, and other information related to an individual patient.

As advanced methods for self-learning and prediction, the system could use artificial neural networks, genetic algorithms, Bayesian methods, estimation theory, fuzzy logic, and the like. The system may learn about the user preferences for performing certain examination procedures and optimizes the user interface accordingly. The system might offer default protocols for performing examinations according to optimized care paths.

The present embodiments may provide a system/software program product operable to accept data from a form-based input device, and to retrieve data from a data base having a medical history of the patient. The software application may include a user interface that implements access rights or other security measures. The user interface may provide user at one facility with access to data associated with the patient and the care plan collected at other facilities.

A “medical facility” as used herein is considered to encompass any location, whether temporary or permanent, where medical treatment may be performed or managed. This includes, but is not limited to hospitals, clinics, nursing facilities, physicians offices, emergency response vehicles, insurance providers, and the like, where access to the data is permitted.

A “customer” or “user” as used herein is considered to encompass medical personnel of all types and functions, including administrative personnel. The level of access to the data of an individual care plan may be limited depending on the function of the user and the relationship of the user to the patient.

The method may include a personalized risk assessment for the individual patient. For prevention or treatment of coronary artery disease, data such as blood values, blood lipids, medication, blood glucose, blood pressure, smoking, and other behavioral aspects of the patient, may be monitored and analyzed. The availability of such data for a patient both facilitates diagnosis of a patient arriving in an emergency, and assists medical personnel in recommending and providing immediate and long term care.

In an aspect, the system and method may include using a form-based entry of symptoms, and related medical data and diagnoses, a rule-based engine, an interface with a care plan implementation system, a data base, and input and output mechanisms. The diagnosis method may be implemented and programmed in an electronic formula or other algorithm. The fields in the formula may be linked to a database, either remote or local, such as a Microsoft SQL-database with a SQL (Structured Query Language) server. Other databases may be used. The system may be operable to add, delete, and/or select data (such as text and/or images) from data files. The system may offer a search mechanism, such as a search engine, operable to search remote databases. For instance, medical personnel at one facility may be able to remotely search a database stored at another facility involved with the performance of the diagnosis and subsequent care plan to gather information about the patient, tests and diagnoses which may be related to the present syndrome and which have previously been performed performed, and other information regarding the patient, including patient characteristics and other healthcare data provided to the patient and which may be unrelated to the care plan (such as medications previously or currently prescribed for the patient and past illnesses treated).

In an aspect, a risk profile for a patient may be prepared and maintained. By analyzing the patient medical history and current medical laboratory test results, the individual patient prognosis for developing coronary artery disease may be assessed. As further data for a patient are obtained, through examinations, tests, studies, and the like they may be added to the data base. To the extent that the data may be subject to statistical analysis, various metabolic data may be analyzed to determine the temporal trends, response to medications, and the like. Where the data is usable in other care plans, such as for stroke, mammography, and the like, the data may be shared between the care plans through the data base.

In another aspect, data may be provided to the data base through telemonitoring of a patient, either in a clinical setting, or as an outpatient. Such data may include blood pressure, heart rate, and other metabolic data that may be monitored, depending on the equipment available. As the medical arts evolve, more and more metabolic data types may be remotely monitored. The data may be analyzed to provide an alert for changes which may be indicative of a coronary artery disease, or other significant metabolic change that ought to be investigated.

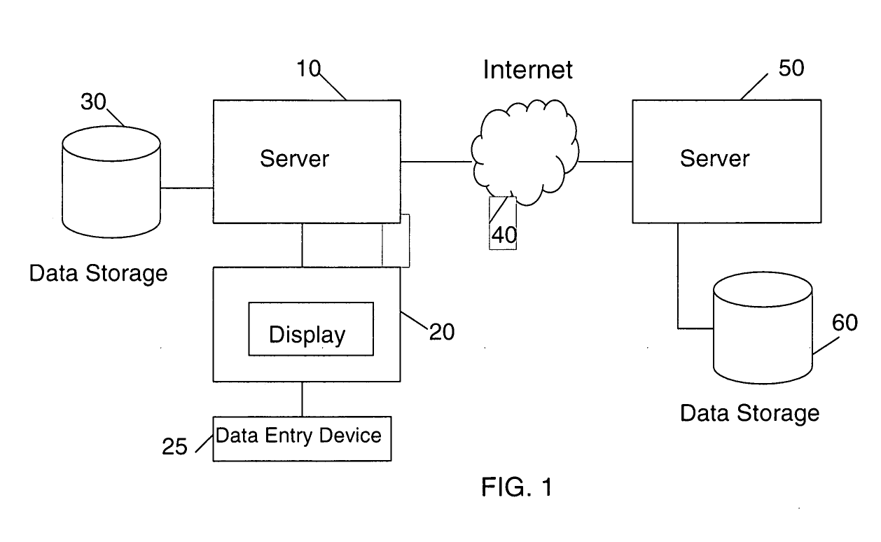

FIG. 1 is an example of a computing system architecture which may be suitable for executing the software programs and managing the data bases associated with the diagnosis and care processes. A server or computer 10 may execute a software product so as to exhibit the functionality described herein, where the server is a computing device having a central processor unit (CPU), memory and interfaces, as is known in the art, and an attached memory system which may be semiconductor memory, a rotating disk 30, magnetic tape, or a combination thereof. Such memories may be local to the server 10, and be connected through interfaces or a local area network (LAN).

In an aspect, the data or data base may be located at another facility and accessed through a wide area network (WAN), which may be the Internet 40, or other telecommunication system. Typically, at least portions of the WAN are provided by others, and the LAN may be an existing shared resource at the local medical facility. The remotely located data base may be stored on a disk 60, or other non-volatile or backed-up volatile memory attached to a server 50 having an interface to the LAN or WAN.

Although only the server 10 at one medical facility is shown, and a single display unit 20 attached, a person of skill in the art of computer networking would understand that a plurality of display units 20, and other interface devices may be in communication with the server 10, and that the term “server” may represent a plurality of computing and storage units in local or remote communication with each other, executing software programs in a centralized or distributed manner. Similarly, the remotely located data base may be accessed by a plurality of servers 10, located at a plurality of medical facilities. The remote data base may represent a plurality of remote data bases which may be accessed by the servers over a network. It also follows that some or all of the remote data bases may actually be located at a medical facility where a server is also located.

Forms may be displayed on a display unit 20, which may be located in an emergency room, an ambulance, doctor's office, or other location convenient to the professional responding with the information solicited by the form. The information may be entered through a keyboard 25, keypad, touch screen or by voice recognition, depending on the location of the data entry device.

In an aspect, data may also be entered remotely, for example, by a diagnostic lab, or by radiology equipment using standard data interface protocols such as DICOM (Digital Communications in Medicine), or may be entered autonomously by telemonitoring equipment which may be attached to the patient. The data may be entered through a telecommunications network and the data path may include wireless portions.

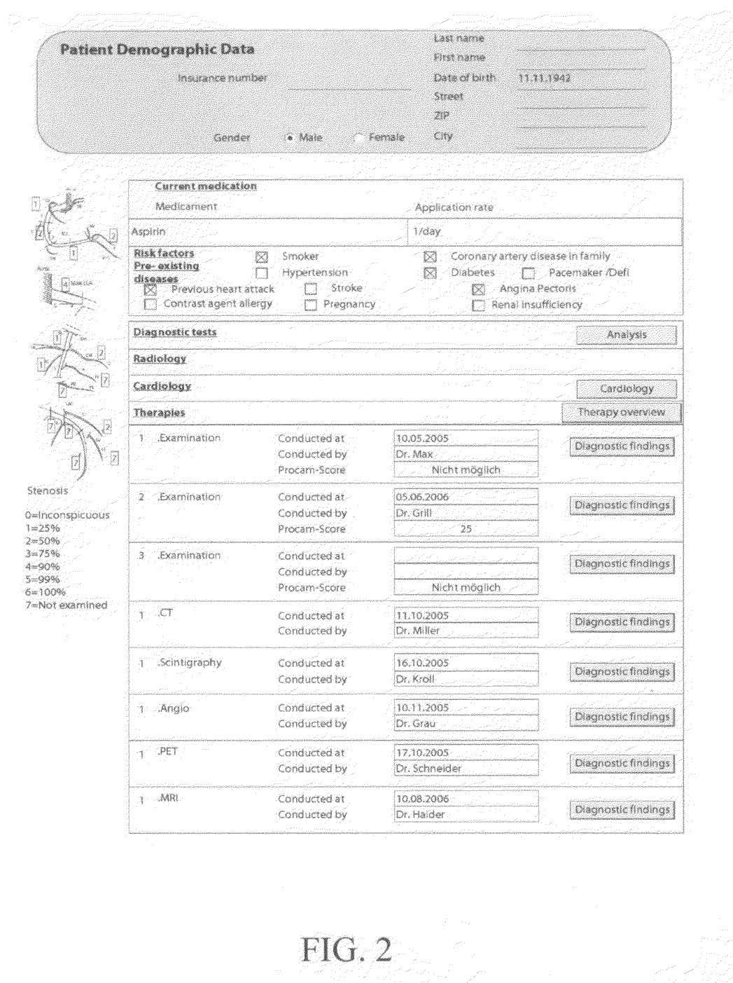

FIGS. 2-6 show examples from a series of questionnaire-based data collection and data display forms. The forms both display data already collected, and serve to order further tests and studies of the patient. These examples are intended to suggest the types of forms that may be developed and used to organize and present data from a patient health information data base, and to manage the diagnosis and care of a patient, both in a medical facility or on an outpatient basis. As such, the forms are illustrative and not intended to limit the scope and functionality of a system of this type. The forms may be adapted to the medical practice in a region, a hospital, or the like, so as to reflect both differences in medical practice, and the availability of diagnostic and testing equipment.

The forms may provide at least a portion of the input data to facilitate the use of a rule-based diagnosis engine. The rule-based engine may have deterministic or probabilistic characteristics, and contain heuristic decision rules based on a “best practices” diagnosis procedure. The procedure may have been adapted to local needs, as the personnel and diagnostic equipment suite may differ. Even at a specific facility, the availability of specific equipment and personnel may be time dependent. The diagnosis engine may also provide a recommended care path of the patient.

As shown in FIG. 2, the form may be used to retrieve information regarding a patient that may be stored at the medical facility. Where a networked system is deployed, such as described in U.S. patent application Ser. No. 11/796,524, filed on Apr. 27, 2007, entitled “Service Module in Clinical Workflow Simulation Tool for Healthcare Institutions”, which is commonly owned and which is incorporated herein by reference, the stored information may be accessed where permitted and as relevant to the present situation. This may be done, for example, by entering the patient's name, an insurance or other identifying number, date of birth, or the like, in the patient data portion of the form. Not all of the fields of the form may need to be completed in order to access a patient record.

Access to the patient data may be controlled by password or other means, including biometric data, as is known in the art, or may later be developed. In this example, the person accessing the forms displayed is presumed to have already completed the process of self-identification to the system for the purposes of gaining access to the information displayed. Depending on the access privileges of the individual, more or less than the information shown in the example may be displayed. The ability to order further examinations, to modify records, and the like, may also depend on the level of access privileges, and the nature of the symptoms being evaluated or treated.

A form, such as shown in FIG. 2, may display or provide for entry of information on the medication currently being administered to the patient, the extent and location of the actual observed stenoses from the most recent examination, and known risk factors for cardiovascular problems. Such risk factors may include smoking, high blood pressure, high cholesterol, angina, previous cardiovascular incidents, diabetes, and the like. The medical professional may then access previous examination results or request new examinations by pressing the “New Examination” button, and a summary of previous examinations may be displayed.

Here, a plurality of previous examinations or treatments have been displayed. The brief record of the examination may include the type of procedure, the date of the procedure, and the person responsible for performing or supervising the procedure. Pressing the “Results” button may cause another form to be displayed with the results of the examination selected.

New examinations, tests or procedures may be selected from a menu in a navigation pane associated with the “New Examination” button, and each of the selections may lead to further menus to further specify the characteristics of the request. Such menus may take into account the availability of equipment and personnel at the local facility, or suggest referrals to another medical facility or specialist for the selected action.

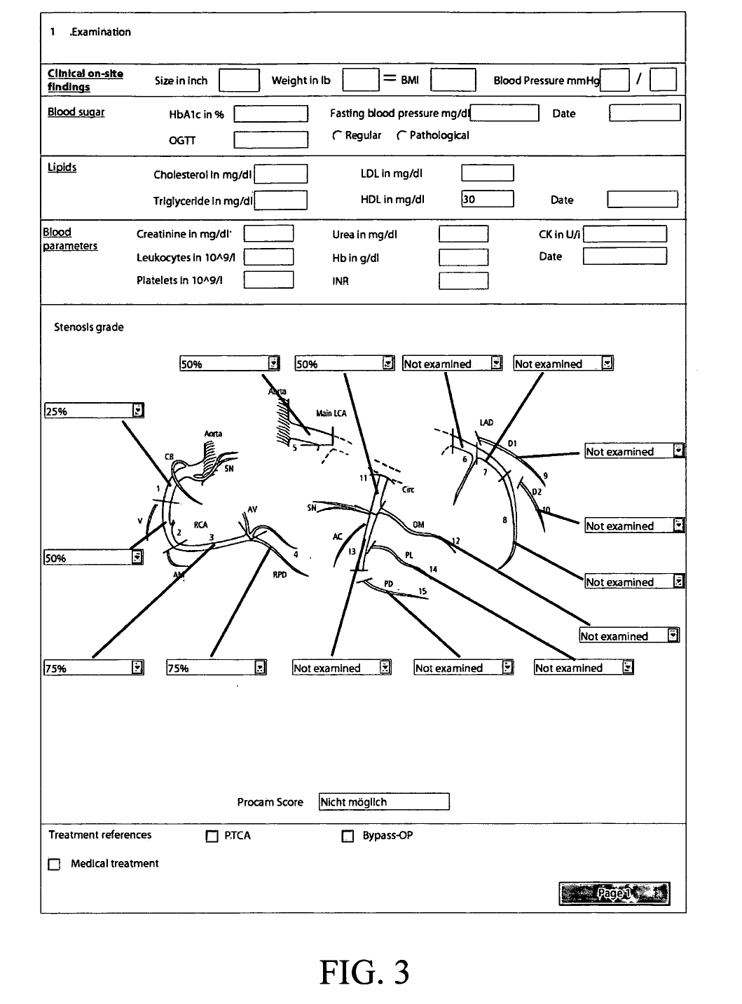

FIG. 3 is an example of a summary of a medical investigation, or study, that includes a patient questionnaire and may have professional observations, and which may be answered with simple “yes”, “no” or “don't know” responses, which may be suitable for use with a rules-based logic engine. Associated laboratory results such as blood chemistry and metric data such as weight, height, blood pressure, and the like, may be presented. Results of radiological and cardiological studies may be summarized with respect to stenoses in a diagram, where the categorization of the severity of the stenoses are also shown.

The medical diagnosis or recommendation based on this investigation may be indicated, and a prose summary of the findings may also be included (not shown). The information may also be entered through drop-down boxes; however, radio buttons, check boxes, and the like, may also be used.

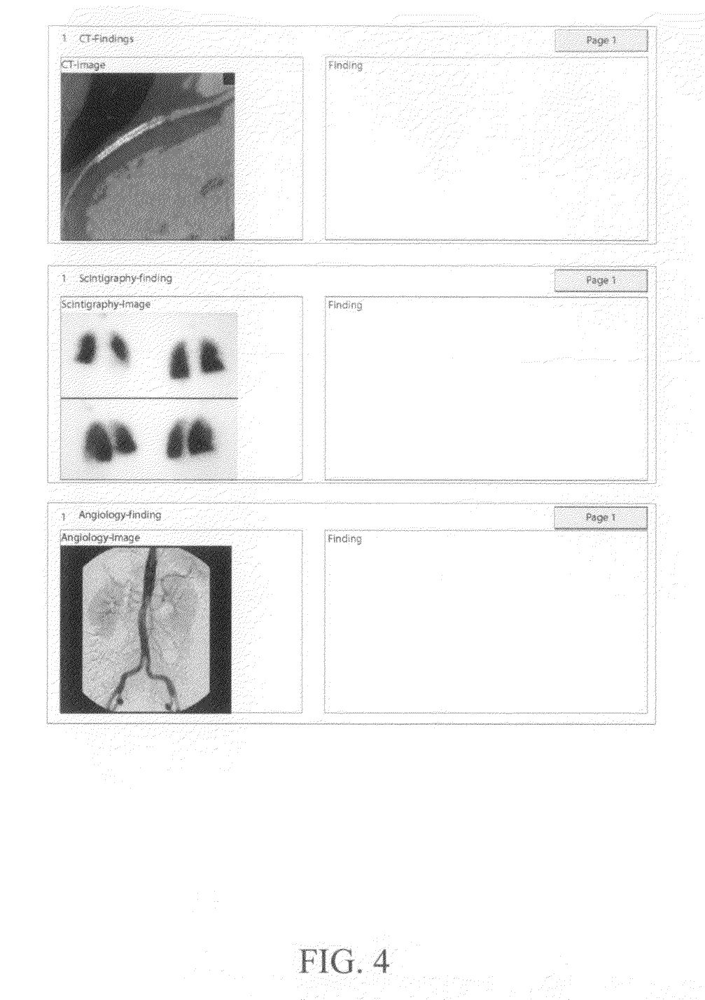

In another form, more detailed examination results may be either entered or presented. For example, as shown in FIG. 4, the results of radiological studies in various modalities may be presented in summary form, so that they may be quickly reviewed. A prose summary provided by the person performing or evaluating each of the examinations may be provided so as to document the professional opinion and interpretation of the results. The underlying detail data may be accessed by, for example clicking on a “Details” button, or in some examples by clicking or double-clicking on the image. In the example shown, while a number of different modalities are provided for in the form, only an angiogram has been performed, and this is the data displayed. From this the user can make a decision as to whether other modalities should be employed to obtain additional data. Having viewed the available data, the user may thus avoid ordering tests that have been previously performed and whose results are considered to be still valid.

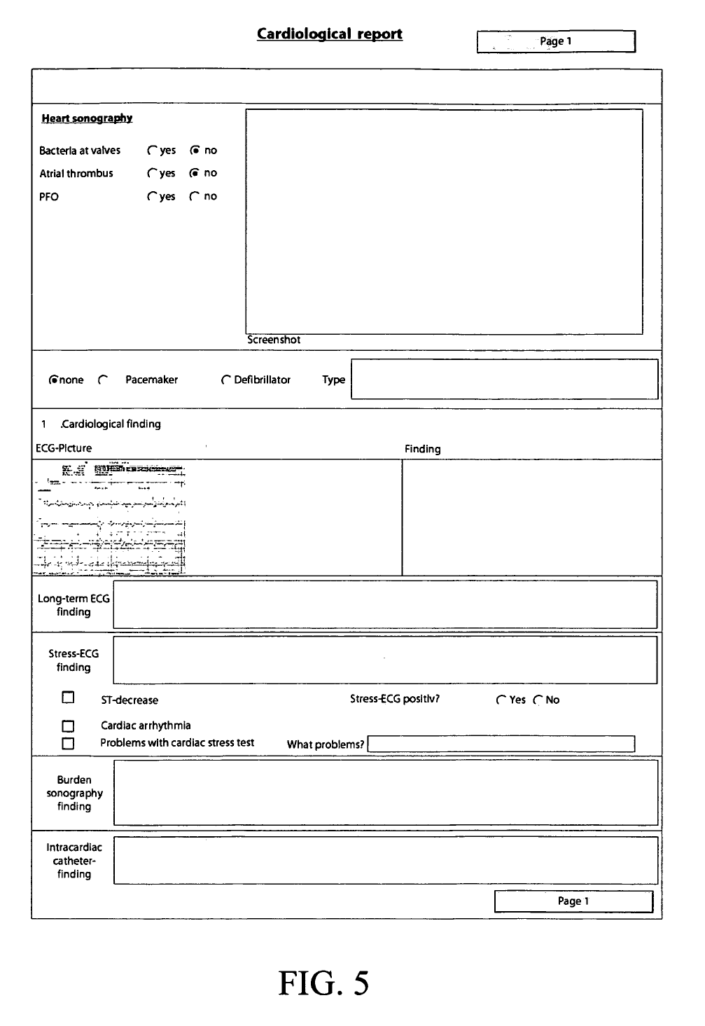

Another example of a form that may be selected is shown in FIG. 5, for the cardiology examination. Here an image of a echocardiogram may be displayed. The image may be a video showing, for example, Doppler measurements of blood flow, and may also have an associated recording of audio sounds of the blood flow. In addition, contemporaneous or historical electrocardiogram (ECG) data may be included. Each of the forms, or regions of the forms may be linked to subsidiary forms, that may be developed or are in use, to obtain the data in a standardized format so that the patient data maybe stored and analyzed using a rules-based engine.

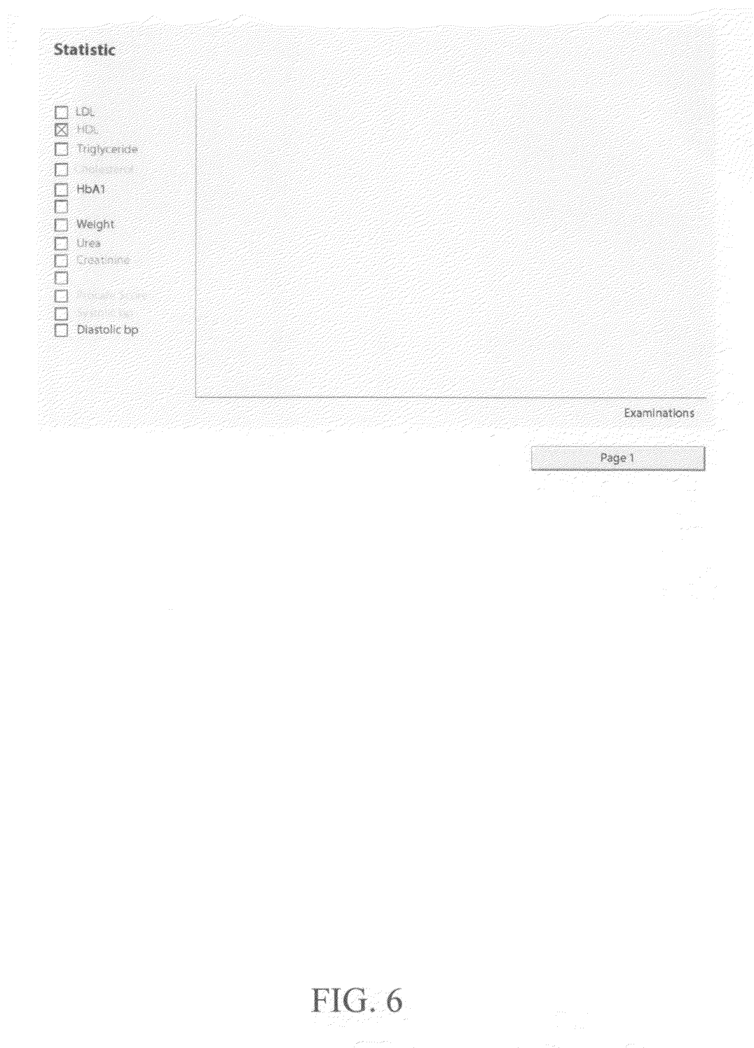

Historical medical data may be used in diagnosis, and a time-series of data of the patient blood chemistry may be displayed, as in FIG. 6. This data may represent the results of laboratory tests extending over a significant period of time, or for data taken during a hospitalization, where time intervals between tests are typically much shorter. Although not shown, the dates of starting and discontinuing specific medications may be indicated, so as to provide a visual correlation with any metabolic changes. Various statistical analysis techniques may be used so as to emphasize data trends, and to assist in the evaluation of the statistical significance of fluctuations in the time series of data.

The results of the various investigations and treatments, only examples of which have been shown, produce raw and analyzed data describing the patient from a medical viewpoint. The data may be quantitative or verbal in nature, and the observational data may be coded in a form suitable for processing by a rules-based engine. Thus, in addition to the medical professional's judgment based on experience, an objective assessment of the patient may be performed based on established medical protocols for the medical institution, taking account of the types of diagnostic data that are available. The user may review the studies and the results of the rule-based engine analysis. Other studies may be ordered, or the user may decide to accept or modify a recommended care plan.

The description of the system and method herein has proceeded somewhat linearly through a group of studies and data for the purposes of exposition. Depending on the available data and the currency of the data, some studies may not need to be performed, while others may need to be performed again as the patient condition can have been expected to change. Multiple versions of the same study may performed at different times in the clinical history of the patient, so as to make an initial diagnosis and decide on a suitable care plan, and to assess the progress of the patient and determine if alterations to the care plan are warranted.

The use of this data is not limited to acute situations, but may be equally useful over a period of time to monitor the patient and associated risk factors, adjust medicine types and doses, provide advice and guidance to the patient, and the like. By keeping a medical history data base up-to-date, the assessment of acute conditions may be expedited, and this may be particularly crucial where rapid intervention may be needed.

While the description has been in terms of the data gathering and data input by personnel in a facility, certain data may be obtained and input by, for example, emergency medical technicians (EMT) who are accompanying the patient to the hospital or other treatment facility in an ambulance or emergency vehicle. The vehicle may be in radio contact by voice or data with the treatment facility, and be able to access patient medical information, or at least complete portions of a questionnaire in transit. As such, the emergency room personnel may be better able to schedule any further diagnostic or confirmatory tests needed by the care plan protocol.

An example of a method of managing the care of a patient having coronary artery disease risk factors or symptoms has been described; this approach may be adapted to a specific facility, and evolve with time as medical knowledge advances.

The methods disclosed herein have been described and shown with reference to particular steps performed in a particular order; however, it will be understood that these steps may be combined, sub-divided, or reordered to from an equivalent method without departing from the teachings of the present invention. Accordingly, unless specifically indicated herein, the order and grouping of steps is not a limitation of the present invention.

While the preferred embodiments of the invention have been described, it should be understood that the invention is not so limited and modifications may be made without departing from the invention. The scope of the invention is defined by the appended claims, and all systems and methods and products that come within the meaning of the claims, either literally or by equivalence, are intended to be embraced therein.

What is claimed is:

1. A method of managing the care path for a patient having cardiovascular risk factors or symptoms, the method comprising:
providing a plurality of computer-displayable data forms, at least one of which provides for a selection of multiple responses to each of a plurality of pre-determined questions;
linking the forms to a data base of the patient medical history data, and retrieving data that is available for the patient;
displaying requested data of available patient medical history;
requesting specific medical tests and studies using selectable buttons on the forms and displaying the results of the requested studies; and
providing a rule-based engine to process at least one of responses entered on the forms, results of specific medical tests, or information from the data base so as to provide at least a recommended care path for cardiovascular care,
wherein the rule-based engine is adapted to conform to the existing diagnostic and treatment procedures at a local medical facility.

2. The method of claim 1, wherein results of medical procedures currently or previously performed are linked to the forms.

3. The method of claim 1, wherein the data associated with responses to the questions of the forms is stored in the patient medical history data base.

4. The method of claim 1, wherein the result of the rule-based engine analysis is a recommended long-term care plan.

5. The method of claim 1, wherein the result of the rule based engine analysis is a recommended acute care plan.

6. The method of claim 1, wherein the forms are displayed on an electronic display, and the data is entered at least in part by a keyboard device.

7. A data processing system for managing the care of patients having cardiovascular risk factors or symptoms, the system comprising:
a data processor operable to:
maintain a form-based data entry device, and a rule-based engine for analyzing data entered on the forms or retrieved from a patient medical history data base;
accept data from at least one of the form-based data entry device or the patient medical history data;
request medical tests using at least one form and display the results of the medical test on a form; and
analyze the data using the rule-based engine to recommend a care path for a patient having cardiological risk factors or symptoms.

8. The data processing system of claim 7, wherein the rule-based engine is adapted to conform to diagnostic procedures and decision criteria of a local medical facility.

9. The data processing system of claim 7, wherein the patient medical history data base is accessed through a telecommunications network.

10. The data processing system of claim 9, wherein the telecommunications network is the Internet.

11. The data base system of claim 7, wherein the data processor receives data input from the form-based data entry device, at least in part over a wireless network.

12. A computer-readable medium having instructions executable on a computer stored thereon, the instructions causing a computer system to:
store and maintain a form-based data entry procedure;
access at least one of a patient history data base, or a care plan protocol;
accept data input to a form or retrieve patient history data;
request medical tests using at least one form and present results of the medical tests on at least one form;
process at least one of the form or retrieved data using a rule-based engine; and
select a care plan for a patient having cardiological risk factors or symptoms consistent with the data.

13. The computer readable medium of claim 12, wherein the rule-based engine is adapted to conform to the diagnostic procedures and decision criteria of a local medical facility.

14. The computer readable medium of claim 14, wherein the care plan is one of a long-term prevention plan or an acute care plan.

15. The computer readable medium of claim 14, wherein the data input to the form is transmitted to the computer system at least in part over a wireless communications link.
